(19) United States
(12) Patent Application Publication
(10) Pub. No.: US 2002/0018203 A1
(43) Pub. Date: Feb. 14, 2002

(54) Spectrophotometer system having active pixel array

(76) Inventors: David R. Battle, Princeton, NJ (US); Harry Oana, Edison, NJ (US)

Correspondence Address: CALFEE HALTER & GRISWOLD, LLP, 800 SUPERIOR AVENUE, SUITE 1400, CLEVELAND, OH, 44114, US

(21) Appl. No.: 09/880,419

(22) Filed: Jun. 13, 2001

Related U.S. Application Data
(60) Provisional application No. 60/224,593, filed on Aug. 11, 2000.

(51) Int. Cl. G01J 3/42

(52) U.S. Cl. 356/319

(57) ABSTRACT

A spectrophotometer measures the color properties of a sample by illuminating the sample with a light source. One or more light beams are sensed by an active pixel diode array where each of the beams are sensed by a different array of diodes in the active pixel sensor. Each of the diode arrays are formed on the same substrate by a CMOS process such that each diode array is automatically aligned to each other during formation. Subsequent mechanical alignment is, thus, eliminated.

### CROSS-REFERENCE TO RELATED APPLICATIONS

This application claims the benefit of U.S. Provisional Application No. 60/224,593 filed Aug. 11, 2000.

### FIELD OF THE INVENTION

The present invention relates to the spectral analysis arts. It finds particular application to a color spectrophotometer having an active pixel sensor that includes an array of photosensors formed on a single chip. It will be appreciated that the present invention will also find application to other color measuring devices such as calorimeters, tristimulus calorimeters, portable spectometers, single and multiple beam spectrophotometers and the like.

### BACKGROUND OF THE INVENTION

Spectrophotometers are instruments used to determine the color of an object under test. They typically include a source of light that illuminates the object and a photodetector that detects and measures light signals reflected from the object. Then, signal processing circuitry connected to the photodetector computes curves or numerical values indicative of color. The general principles of construction and use of these instruments are well known and understood by those skilled in the art.

One known type of spectrophotometer uses an integrating sphere in which the light reflected from the object is integrated to obtain an average reading of the color over an exposed surface area of the object. Known integrating spheres can provide readings which represent “total” reflections or “diffuse-only” reflections. The total reflections include all reflections from the exposed object, including specular reflections from the surface and diffuse reflections from particles in the body of the object. A “diffuse-only” or specular-excluded measurement is obtained by excluding specular light that is reflected from the surface of the sample at an angle equal to the incident angle. This reflected light is referred to as the specular component. Exclusion of the specular component eliminates the light contribution due to gloss, and the color values obtained from a specular-excluded reading are independent of the glossiness of the surface of the object under test.

The specular angle is equal and opposite to the angle of incidence of a source light beam projected onto the sample object under test. A typical angle for the source light beam in prior art arrangements is 8 degrees off the vertical centerline of the sphere which is also perpendicular to the sample. The specular-excluded reading is obtained in such a sphere by providing a light-absorbing area on the sphere at 8 degrees off the centerline and on the opposite side of the centerline from the photodetector. The absorbing spot, also known as a specular port, may be created by an opening in the outer surface of the sphere with a dark area or black plug placed in the opening to absorb the specular component.

Most modern color measurement spectrophotometers use a concave holographic grating to split a light beam reflected from a sample into its spectral components which are then imaged onto a linear diode array. This diode array can be a small self scanned CMOS array (complimentary metal oxide semiconductor), a CCD array (charge coupled device) or a discrete array of photodiodes connected to an external multiplexer circuit. In the past, companies have used a five (5) beam spectrophotometer that uses a two (2) dimensional CCD array in a color measurement spectrophotometer.

These prior diode arrays are not ideal and suffer from the following problems:

(1) Discrete array of diodes tend to be much larger (for example 25-50 mm long) than CCD or CMOS self scanned arrays but can provide superior noise performance. They have a limited number of pixels across the spectrum, typically, 40 diodes from 360 nm-750 nm forcing the instrument to have a high bandwidth (for example 10 nm).

(2) CCD arrays are smaller (for example 5-10 mm long), provide 100-1000 pixels and come on an integrated circuit. They are either too expensive if they have good noise performance, or are cheap with poor noise performance.

(3) A CMOS Self Scanned array provides 100-300 pixels, is about 10 mm long and has a lower cost. However, they typically have poor noise performance.

For multi-beam measurement devices, arrays of photodiodes are used to measure each beam. Each array is made separately and when the measurement device is built, multiple arrays are mechanically aligned together to form a sensor array. Mechanically alignment introduces potential alignment errors that can reduce the accuracy of the measurements. Additionally, diode arrays that are manufactured separately may have different electrical and thermal properties that may affect the accuracy of the measurements.

The present invention provides a new and unique color measuring device that cures the above problems and others.

### SUMMARY OF THE INVENTION

In accordance with the present invention, a new and unique spectrophotometer for measuring color properties of an object is provided. The spectrophotometer includes a light source that transmits light onto the object. An active pixel sensor senses the light reflected from the object and generates electrical signals corresponding to color properties of the sensed light. The active pixel sensor includes an array of photosensors formed on a common substrate and formed together during a fabrication process where the photosensors are aligned during the fabrication process without subsequent mechanical alignment.

In accordance with another aspect of the present invention, the active pixel sensor is configured to measure a plurality of light beams on a single chip for use in a color measurement spectrophotometer.

One advantage of the present invention is that a multiple beam active pixel sensor is provided including light receiving diode arrays that are formed on the same chip and fabricated at the same time either as a two dimensional array or as one or more linear arrays. The arrays have similar electrical and thermal properties since they are fabricated together.

Still further advantages of the present invention will become apparent to those of ordinary skill in the art upon reading and understanding the following detailed description of the preferred embodiments.

### BRIEF DESCRIPTION OF THE DRAWINGS

The following is a brief description of each drawing used to describe the present invention, and thus, are being presented for illustrative purposes only and should not be limitative of the scope of the present invention, wherein:

FIG. 1 illustrates an exemplary active pixel sensor having two arrays of photosensors formed on a single chip in accordance with the present invention;

FIG. 2 illustrates an exemplary active pixel sensor having a two dimensional array of photosensors formed on a single chip in accordance with the present invention; and

FIG. 3 illustrates an exemplary dual beam spectrophotometer with an active pixel sensor in accordance with the present invention.

### DETAILED DESCRIPTION OF THE PREFERRED EMBODIMENTS

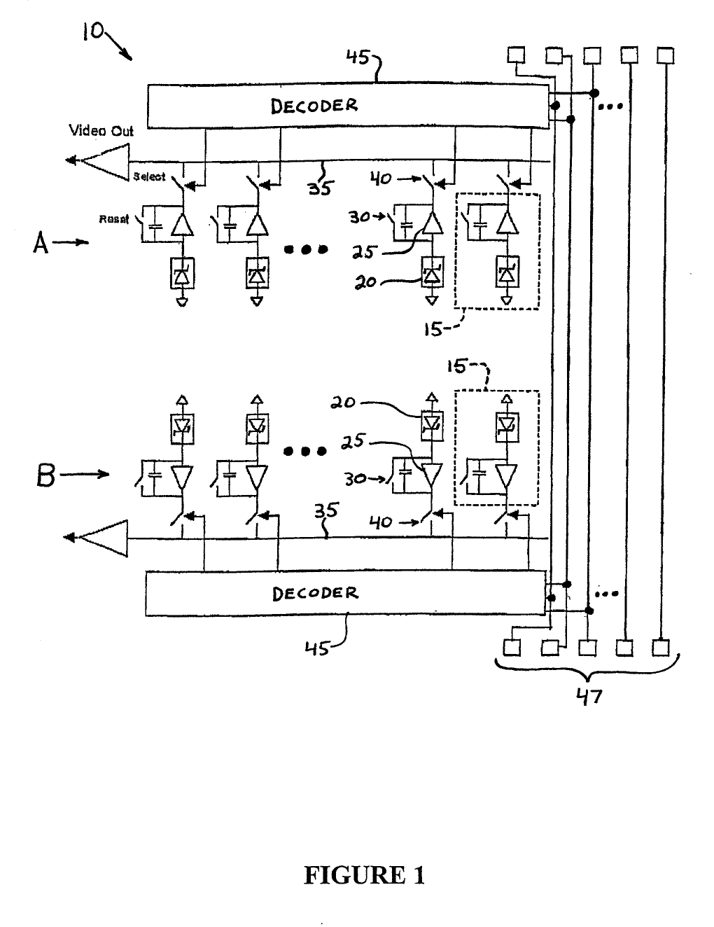

With reference to FIG. 1, an exemplary active pixel sensor 10 is shown. The sensor includes two linear arrays A and B of pixels 15 that are photosensitive elements. Each pixel, for example, includes a photodiode 20 connected to an amplifier 25 that can also function as a buffer. Alternately, the amplifier can be substituted with an integrator or other known devices. The amplifier boosts the output signal from diode 20 and improves the signal to noise ratio. A reset switch 30 is connected across the amplifier 25. Each pixel 15 is connected to an output signal line 35 through a selection gate 40. Each selection gate 40 is controlled by a decoder 45 that randomly or sequentially allows the data on each pixel to be transferred to the output signal line 35. The decoder 45, for example, is a multiplexer. A separate decoder is used to control each array of pixels. Each pixel 15 has an associated address and the decoder selects pixels based on an address supplied by address lines 47. It will be appreciated that other circuit elements can be connected to each pixel or to the sensor in order to additionally process its output signals as is known in the art, for example, to reduce noise, to enhance the signal, to buffer, etc.

With the illustrated architecture of FIG. 1, the sensor 10 can measure spectral components of two light beams, one per pixel array. Of course, any number of pixel arrays can be formed based on how many beams are to be measured, for example one or more arrays. Furthermore, any number of pixels 15 can be included in each array in order to measure the spectral components of a beam. As will be described in greater detail below, a light beam is split into its spectral components which are then focused across an array of photosensor pixels. By increasing the number of pixels, the accuracy of the spectral measurement increases.

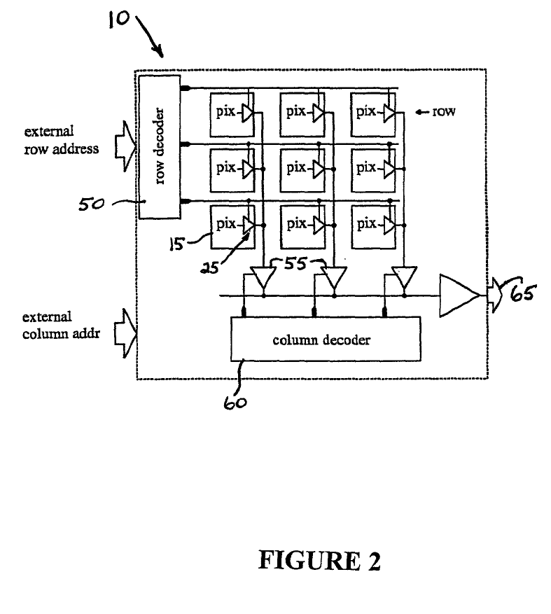

With reference to FIG. 2, another exemplary active pixel image sensor 10 is shown having a two dimensional array of pixels 15 that are arranged in a column and row structure. A row address decoder circuit 50 accesses the pixels 15 of one complete row in parallel and their signals are fed to the input of column buffers 55. A column address decoder circuit 60 selects the column buffers sequentially and their signal is buffered to the sensor output 65. It will be appreciated that the sensor can be modified in order to randomly access selected pixels as is, known in the art.

The active pixel sensor 10 and its diode arrays are formed on the same silicon chip or substrate, either as a series of linear arrays as shown FIG. 1 or as a two dimensional array as shown in FIG. 2. The arrays are fabricated by a standard complimentary metal oxide semiconductor (CMOS) process. In this manner, forming the diode arrays on the same chip automatically aligns the diodes and the alignment is to semiconductor tolerances (for example, microns) and eliminates the need to mechanically align separate diode arrays to each other when building a spectrophotometer or other color measuring device. With this process, the diode arrays have similar electrical and thermal properties since they are fabricated at the same time on the same piece of silicon or other substrate. The sensor 10 can be fabricated using an N well CMOS process such that electrons function as the photo-generated charge carriers and it operates from +5 volts. A P well CMOS process may also be used to fabricate the sensor such that holes function as the photo-generated charge carriers and which would run from −5 volts.

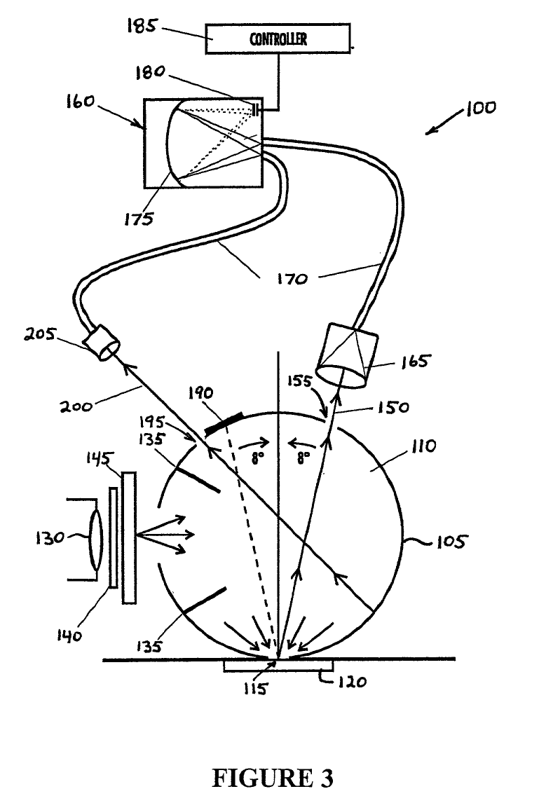

With reference to FIG. 3, an exemplary spectrophotometer 100 incorporating a diode array 10 formed by the present invention is shown. The spectrophotometer 100 may be a portable hand-held device or a bench-top device as is known in the art. The spectrophotometer 100 includes an integrating sphere 105 that is hollow and has an inner surface 110 that is highly reflective. For example, the inner surface can have a BaSO₄ coating or other coating as is known in the art. A sample port 115 is an opening formed in the sphere where a sample object 120 is placed whose color is to be measured by the system 100. A center line 125 of the sphere 105 is shown for reference purposes and is a line normal to the sample 120. A light source 130 is mounted to the sphere to provide light within the sphere and diffusely illuminate the sample 120 at all angles. The light source, however, is configured so that it does not directly illuminate the sample. This can be achieved by using, for example, baffles 135 as known in the art. The light source 130 is, for example, a xenon flashlamp. The light source may also include a D65 filter 140 and/or a filter wheel 145 as is known in the art such that only selected wavelengths of light enter the sphere.

With further reference to FIG. 3, the sample 120 to be measured is placed at the sample port 115 where it is diffusely illuminated (e.g. from all angles) by the light source. Light reflected from the sample, for example, at 8° from the normal 125 is collected and passes through a light port 155 in the sphere to a spectral analyzer 160 by passing through a lens 165 and a fiberoptic cable 170. Of course, the spectral analyzer can be positioned to be directly connected with the lens 165 and adjacent the sphere 105 without requiring a fiberoptic cable. The spectral analyzer includes a concave holographic defraction grating 175 that splits the light beam 150 into its spectral components. It is to be appreciated that other devices are known in the art to split light into its component colors such as other types of gratings and prisms. The split spectral components are then focused onto an active pixel diode array 180 which corresponds to the sensor 10 described above. Output from the active pixel array 180 is then sent to a controller 185 that processes the output and displays the spectral properties of the light measured by the diode array 180 as is known in the art.

With further reference to FIG. 3, the exemplary sphere 105 includes a specular port 190 also known as a gloss trap positioned opposite from the light port 155. In other words, it is positioned at 8° from the other side of the normal line 125. The specular port is a portion of the sphere that can be removed by a motorized mechanism or by hand to reveal a light trap. The specular component of a measurement results from a mirror-like reflection from a shiny surface, thus, if no light is incident on a sample at 8° due to the light trap 190 in place, then no light can be reflected at 8°. As a result, the reflected beam 150 should only include diffusely reflected light.

The exemplary sphere 105 also includes a reference port 195 that allows a second beam of light called a reference beam 200 to exit the sphere. The reference beam 200 is light reflected from the interior wall of the sphere 105. A reference lens 205 then directs the reference beam to the spectral analyzer 160 through the fiberoptic cable 170. The reference beam 200 is also split into its spectral components by the grating 175 and focused on the active pixel diode array 180 to be measured. The reference beams allows direct measurement of reflectants between the ratio of reflected light and incident light. This type of system is also known as a dual-beam spectrophotometer. One of ordinary skill in the art will appreciate that a spectrophotometer can be configured to measure one beam, two beams, three beams, four beams or more as is known in the art with a corresponding structure of sensor arrays.

The active pixel array 180 is formed as described above. The photodiodes are formed on a single substrate during a CMOS fabrication process such that the diode arrays, two in this example, are automatically aligned during formation and thus eliminating the need for mechanical alignment of each array. In this manner, multiple beam systems can be formed on one chip that improves alignment of arrays and hence improves wavelength alignment. Using a standard CMOS process also allows fabrication of smaller pixel widths, for example 24 microns, resulting in improved wavelength resolution and alignment.

The invention has been described with reference to the preferred embodiment. Obviously, modifications and alterations will occur to others upon a reading and understanding of this specification. It is intended to include all such modifications and alterations insofar as they come within the scope of the appended claims or the equivalence thereof.

We claim:

1. A spectrophotometer for measuring color properties of an object comprising:
a light source for transmitting light onto the object,
an active pixel sensor for sensing light reflected from the object and generating electrical signals corresponding to color properties of the sensed light, the active pixel sensor including an array of photosensors formed on a common substrate and formed together during a fabrication process where the photosensors are aligned during the fabrication process without subsequent mechanical alignment.

2. The spectrophotometer as set forth in claim 1 wherein the fabrication process is a complimentary metal oxide semiconductor process.

3. The spectrophotometer as set forth in claim 1 further including at least two arrays of photosensors formed on the common substrate aligned in parallel to each other, the at least two arrays being formed and aligned during the fabrication process of the common substrate.

4. The spectrophotometer as set forth in claim 3 wherein each of the at least two arrays of photosensors sense a different beam of reflected light from the light source.

5. The spectrophotometer as set forth in claim 1 wherein the photosensors are photodiodes.

6. The spectrophotometer as set forth in claim 5 wherein the active pixel sensor includes one of an amplifier and an integrator connected to each of the photo sensors.

7. The spectrophotometer as set forth in claim 1 further including an integrating sphere including:
a light source opening that allows the light source to illuminate an interior of the integrating sphere;
an object aperture that allows a portion of the object to be exposed to the interior of the integrating sphere; and
a light aperture that allows the reflected light from the object to pass through, the active pixel sensor being in optical communication with the light aperture to sense the reflected light.

8. The spectrophotometer as set forth in claim 7 further including a reference light aperture that allows light reflected from the interior of the object to pass through, the active pixel sensor being in optical communication with the reference light aperture to sense the reflected light.

9. The spectrophotometer as set forth in claim 1 wherein the active pixel sensor is an n-channel device having electrons as photo-generated charge carriers.

10. The spectrophotometer as set forth in claim 1 wherein the active pixel sensor is a p-channel device.

11. A spectrophotometer for measuring spectral properties of an object comprising:
an integrating sphere having a reflective interior surface, the integrating sphere including an object port for exposing a portion of the object to the interior of the sphere;
a light source for illuminating the interior of the sphere and the portion of the object with light; and
an active pixel sensor for sensing light reflected from the object and generating electrical signals corresponding to spectral properties of the sensed light, the active pixel sensor including at least two photosensors arrays formed on a common substrate and formed together during a fabrication process where the at least two photosensors arrays are aligned during the fabrication process without subsequent mechanical alignment, each of the at least two photosensor arrays measuring a different beam of light from within the integrating sphere.

12. The spectrophotometer as set forth in claim 11 wherein the at least two photosensor arrays are a series of linear arrays.

13. The spectrophotometer as set forth in claim 12 wherein the linear arrays include:
a first photosensor array for sensing light reflected from the object; and
a second photosensor array for sensing light reflected from an interior wall of the integrating sphere.

14. The spectrophotometer as set forth in claim 12 wherein the at least two photosensor arrays are aligned forming a two dimensional array.

15. The spectrophotometer as set forth in claim 11 wherein the at least two photosensor arrays include an array of photodiodes each connected to an amplifier.

16. The spectrophotometer as set forth in claim 11 wherein the at least two photosensor arrays include an array of photodiodes each connected to an integrator.
